(19) United States
(12) Patent Application Publication
(10) Pub. No.: US 2025/0201918 A1
(43) Pub. Date: Jun. 19, 2025

(54) ELECTROLYTE FOR LITHIUM SECONDARY BATTERIES AND LITHIUM SECONDARY BATTERIES COMPRISING THE SAME

(71) Applicants: Hyundai Motor Company, Seoul (KR); Kia Corporation, Seoul (KR); Korea Advanced Institute of Science and Technology, Daejeon (KR)

(72) Inventors: Hui Beom NAM, Suwon-si (KR); Yoon Sung LEE, Suwon-si (KR); Sung Ho BAN, Hwaseong-si (KR); Tae Rim LEE, Hwaseong-si (KR); Jun Ki RHEE, Seoul (KR); Yong Ho LEE, Incheon (KR); Nam-Soon CHOI, Daejeon (KR); Hyeon Gyu MOON, Daejeon (KR)

(73) Assignees: Hyundai Motor Company, Seoul (KR); Kia Corporation, Seoul (KR); Korea Advanced Institute of Science and Technology, Daejeon (KR)

(21) Appl. No.: 18/657,349

(22) Filed: May 7, 2024

(30) Foreign Application Priority Data
Dec. 14, 2023 (KR) 10-2023-0181961

(51) Int. Cl. H01M 10/0567; H01M 4/66; H01M 10/0525; H01M 10/0569

(52) U.S. Cl. CPC H01M 10/0567; H01M 4/663; H01M 4/667; H01M 10/0525; H01M 10/0569; H01M 2300/0037

(57) ABSTRACT

In an electrolyte for the lithium secondary battery, which is used in forming protective layers on the surfaces of positive and negative electrodes, the electrolyte contains 1-vinyl-1,2,4-triazole additives. In the instant case, vinylene carbonate further contained in the additives stabilizes the protective layer on the surface of the negative electrode, and 1,3-propane sultone further contained in the additives stabilizes the protective layer on the surface of the positive electrode, thereby improving the long-term life performance and high-temperature life characteristics of the lithium secondary battery.

### CROSS REFERENCE TO RELATED APPLICATION

The present application claims priority to Korean Patent Application No. 10-2023-0181961, filed Dec. 14, 2023, the entire contents of which is incorporated herein for all purposes by this reference.

### BACKGROUND OF THE PRESENT DISCLOSURE

### Field of the Present Disclosure

The present disclosure relates to an electrolyte for lithium secondary batteries, which contains 1-vinyl-1,2,4-triazole additives and is used in forming protective layers on the surfaces of positive and negative electrodes, thereby improving the long-term life performance and high-temperature life characteristics of the lithium secondary batteries.

### Description of Related Art

A lithium secondary battery is widely used in a portable energy storage system, an electric vehicle, etc. for reasons of its high energy density, inexpensiveness, long cycle life, and safety. The development of lithium secondary batteries to have high energy density and long lifespan is attracting attention.

Such a lithium secondary battery includes four key elements of a positive electrode, a negative electrode, a separator, and an electrolyte, and is varied in performance depending on the material characteristics of these elements. Recently, battery ignition and explosion issues have discouraged the growth of medium and large battery markets for an electric vehicle, an energy storage system (ESS), etc.

In addition, the low price, fast charging, fast discharging, and high safety of the battery are necessary to commercialize the electric vehicle, and the high-performance electrolyte solvents and additives for a lithium-ion battery are emphasized to improve the performance and safety of the battery.

A LiFePO₄ (LFP) positive electrode is not structurally varied depending on charging, and excellent in thermal stability in a charged state. The LFP positive electrode having an olivine-based structure exhibits a low electrical conductivity of (2.6×10⁻⁹ S/cm, cf. LCO: ˜10⁻³ S/cm) because oxygen is so strongly bonded in a hexagonal form that lithium ions cannot move smoothly.

The LiFePO₄ (LFP) positive electrode has the three-dimensional olivine structure based on a strong P—O covalent bond, thereby having excellent thermal stability, no structural change upon charging, and no structural change even when heated in the charged state.

When the particles of a LiFePO₄ (LFP) positive electrode active material are reduced to nano-sized particles, a travel distance of lithium ions is shortened, thereby improving rate characteristics.

The capacity (theoretical capacity: 170 mAh/g for FePO₄) and the voltage plateau (3.2 to 3.4 V) are low, and the electronic conductivity and the ionic conductivity are low due to the nature of the olivine-based positive electrode. In particular, the energy efficiency is significantly lowered at a low temperature.

To solve these problems, it is necessary to develop an electrolyte system for improving the high-temperature storage, low-temperature output characteristics, and long-term life performance of an LFP positive-electrode battery.

The information disclosed in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing an electrolyte for a lithium secondary battery, which contains 1-vinyl-1,2,4-triazole additives and is used in forming a protective layer on the surfaces of positive and negative electrodes, thereby improving the long-term life performance and high-temperature life characteristics of the lithium secondary battery.

Technical problems to be solved in the present disclosure are not limited to the forementioned technical problems, and other unmentioned technical problems can be clearly understood from the following description by a person having ordinary knowledge in the art to which the present disclosure pertains.

According to an exemplary embodiment of the present disclosure, an electrolyte for a lithium secondary battery includes: a lithium salt; a non-aqueous organic solvent; and additives including 1-vinyl-1,2,4-triazole.

For example, the lithium salt may include LiPF₆.

For example, the electrolyte may include the lithium salt at a concentration of 0.8 to 3.0 M.

For example, the content of 1-vinyl-1,2,4-triazole may be 0.05 to 0.2 wt % based on 100 wt % in total of the electrolyte.

For example, the additives may further include vinylene carbonate.

For example, the content of vinylene carbonate may be 1.0 to 2.5 wt % based on 100 wt % in total of the electrolyte.

For example, the additives may further include 1,3-propane sultone.

For example, the content of 1,3-propane sultone may be 1.0 to 1.5 wt % based on 100 wt % in total of the electrolyte.

According to another exemplary embodiment of the present disclosure, a method of producing an electrolyte for a lithium secondary battery includes: preparing a non-aqueous organic solvent; and adding a lithium salt and additives to the non-aqueous organic solvent, wherein the additives include 1-vinyl-1,2,4-triazole.

For example, the non-aqueous organic solvent may include at least one selected from a non-aqueous organic solvent group consisting of ethylene carbonate, ethyl methyl carbonate (EMC), dimethyl carbonate (DMC) and mixtures thereof.

For example, the lithium salt may include LiPF₆.

For example, the adding the lithium salt and the additives may include adding LiPF₆ at a concentration of 0.8 to 3.0 M based on the electrolyte.

For example, the adding the lithium salt and the additives may include adding 1-vinyl-1,2,4-triazole by 0.05 to 0.2 wt % based on 100 wt % in total of the electrolyte.

For example, the additives further include vinylene carbonate.

For example, the adding the lithium salt and the additives may include adding vinylene carbonate by 1.0 to 2.5 wt % based on 100 wt % in total of the electrolyte.

For example, the additives further include 1,3-propane sultone.

For example, the adding the lithium salt and the additives may include adding 1,3-propane sultone by 1.0 to 1.5 wt % based on 100 wt % in total of the electrolyte.

According to various exemplary embodiments of the present disclosure, a lithium secondary battery including: the foregoing electrolyte for the lithium secondary battery; a positive electrode including a positive electrode active material that contains a material represented by chemical formula 1; and a negative electrode including a negative electrode active material that contains any one of a carbon-based material, a silicon-based material, or mixtures thereof,

LiFeMPO₄ [Chemical formula 1]
where, M is Ni, Co, Mn, Cr, Zr, Nb, Cu, V, Ti, Zn, Al, Ga and Mg.

For example, the surface of the positive electrode active material may be coated with carbon.

According to an exemplary embodiment of the present disclosure, the protective layers are formed on the positive and negative electrodes through the electrolyte for the lithium secondary battery, which contains 1-vinyl-1,2,4-triazole additives, thereby improving the long-term life performance and high-temperature life characteristics of the lithium secondary battery.

The effects to be obtainable from the present disclosure are not limited to the forementioned effects, and other unmentioned effects can be clearly understood from the following description by a person having ordinary knowledge in the art to which the present disclosure pertains.

### BRIEF DESCRIPTION OF THE DRAWINGS

FIG. 1 shows a structural formula of 1-vinyl-1,2,4-triazole, i.e., additives contained in an electrolyte for a lithium secondary battery according to an exemplary embodiment of the present disclosure.

FIG. 2 shows a structural formula of vinylene carbonate, i.e., additives contained in an electrolyte for a lithium secondary battery according to an exemplary embodiment of the present disclosure.

FIG. 3 shows a structural formula of 1,3-propane sultone, i.e., additives contained in an electrolyte for a lithium secondary battery according to an exemplary embodiment of the present disclosure.

FIG. 4 is a flowchart showing how to produce an electrolyte for a lithium secondary battery according to an exemplary embodiment of the present disclosure.

FIG. 5 is a graph showing discharge capacity of a battery according to charging and discharging cycles of embodiments and comparative examples.

FIG. 6 is a graph showing capacity retention of a battery life according to contents of additives under high-temperature conditions.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The terms and words used in the present specification and clams should not be construed as limited to ordinary or lexical meanings, but should be construed as the meanings and concepts consistent with technical spirit of the present disclosure based on the principle that the inventor can properly define the concept of terms to describe his or her own disclosure in the best way.

The terms used in the present specification are only for describing exemplary embodiments, but not intended to limit the present disclosure. Unless the context clearly dictates otherwise, singular forms include plural forms as well.

In the present specification, it should be understood that the term “include,” “comprise” or “have” indicates that a feature, a number, a step, an element, or the combination thereof described in the exemplary embodiments is present, but does not preclude a possibility of presence or addition of one or more other features, numbers, steps, elements, or combinations thereof in advance.

According to an exemplary embodiment of the present disclosure, protective layers are formed on positive and negative electrodes through an electrolyte for a lithium secondary battery, which contains 1-vinyl-1,2,4-triazole additives. In the instant case, the present disclosure relates to the electrolyte for the lithium secondary battery, in which vinylene carbonate further contained in the additives stabilizes the protective layer on the surface of the negative electrode, and 1,3-propane sultone further contained in the additives stabilizes the protective layer on the surface of the positive electrode, thereby improving the long-term life performance and high-temperature life characteristics of the lithium secondary battery.

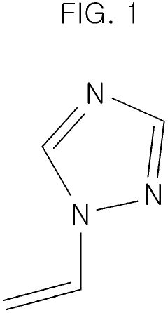

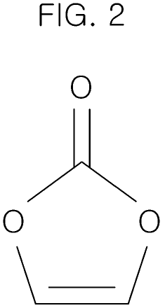

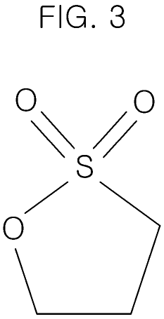

FIG. 1 shows a structural formula of 1-vinyl-1,2,4-triazole, i.e., additives contained in an electrolyte for a lithium secondary battery according to an exemplary embodiment of the present disclosure, FIG. 2 shows a structural formula of vinylene carbonate, i.e., additives contained in the electrolyte for the lithium secondary battery according to an exemplary embodiment of the present disclosure, and FIG. 3 shows a structural formula of 1,3-propane sultone, i.e., additives contained in the electrolyte for the lithium secondary battery according to an exemplary embodiment of the present disclosure. With reference to FIG. 1, FIG. 2, and FIG. 3, the electrolyte for the lithium secondary battery according to an exemplary embodiment of the present disclosure will be described.

The electrolyte for the lithium secondary battery according to an exemplary embodiment of the present disclosure may contain a lithium salt; a non-aqueous organic solvent; and additives containing 1-vinyl-1,2,4-triazole.

Furthermore, the content of 1-vinyl-1,2,4-triazole may be 0.05 to 2.0 wt % based on 100 wt % in total of the electrolyte.

Meanwhile, the additives may further contain vinylene carbonate.

The content of vinylene carbonate may be 1.0 to 2.5 wt % based on 100 wt % in total of the electrolyte.

The additives may further contain 1,3-propane sultone.

The content of 1,3-propane sultone may be 1.0 to 1.5 wt % based on 100 wt % in total of the electrolyte.

1-vinyl-1,2,4-triazole may decompose on the surface of the negative electrode and form a layer that protects the negative electrode. This may be because 1-vinyl-1,2,4-triazole has a low lowest unoccupied molecular orbital (LUMO) level to decompose easily on the surface of a graphite negative electrode and has a double bond structure in a molecule to form a polymer film on the surface of the negative electrode.

1-vinyl-1,2,4-triazole forms a nitrogen-based cathode electrolyte interphase (CEI) layer excellent in high-temperature durability in the positive electrode. With this, the elution of transition metal from the positive electrode is suppressed, and the self-discharge of a secondary battery is alleviated, thereby improving high-temperature durability performance and cycle performance, and thus improving the high-temperature durability performance of the battery.

Furthermore, the electron-rich triazole structure of 1-vinyl-1,2,4-triazole effectively forms a coordination structure in the electrolyte so that Fe²⁺ ions eluted from the positive electrode cannot be electrodeposited on the negative electrode, and the nitrogen atoms present in the molecular structure of 1-vinyl-1,2,4-triazole stabilizes a LiPF₆ (LFP) salt to improve the high-temperature life characteristics of the battery.

Such properties of 1-vinyl-1,2,4-triazole may cause the lithium secondary battery using an LFP-based positive electrode active material, of which the electronic conductivity and the ionic conductivity are low, to be improved in high-temperature storage, low-temperature output characteristics, and long-term life performance.

Specifically, the content of 1-vinyl-1,2,4-triazole may be 0.05 to 0.2 wt % based on 100 wt % in total of the electrolyte for the lithium secondary battery.

When the content of 1-vinyl-1,2,4-triazole is more than 0.05 wt %, the stability of a solid electrolyte interphase (SEI) layer increases to prevent resistance from increasing at high temperature and suppress the generation of gas. When the content is less than 0.2 wt %, the thickness of a generated layer is prevented from being excessively increased, thereby suppressing the increasing resistance of the battery due to charging and discharging.

In addition, the additives may further contain vinylene carbonate.

Vinylene carbonate may stabilize the layer formed on the negative electrode through 1-vinyl-1,2,4-triazole.

Specifically, the content of vinylene carbonate may be 1.0 to 2.5 wt % based on 100 wt % in total of the electrolyte.

As will be described in the following embodiments, the electrolyte for the lithium secondary battery, in which the corresponding content range of vinylene carbonate is satisfied, exhibits excellent performance.

In addition, the additives may further contain 1,3-propane sultone.

1,3-propane sultone may stabilize a layer formed on the positive electrode through 1-vinyl-1,2,4-triazole.

Specifically, the content of 1,3-propane sultone may be 1.0 to 1.5 wt % based on 100 wt % in total of the electrolyte.

As will be described in the following embodiments, the electrolyte for the lithium secondary battery, in which the corresponding content range of 1,3-propane sultone is satisfied, exhibits excellent performance.

Meanwhile, in the electrolyte for the lithium secondary battery according to an exemplary embodiment of the present disclosure, the lithium salt contained as the electrolyte may include lithium salts typically used in the electrolyte for the lithium secondary battery without limitation.

For example the lithium salt consists of a positive ion of Li⁺, and a negative ion of at least one selected from a group consisting of F⁻, Cl⁻, Br⁻, I⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, PO₂F₂⁻, PF₄C₂O₄⁻, PF₂C₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

Meanwhile, the concentration of the lithium salt may be appropriately varied within a typically applicable range. To have an optimal effect on forming an anticorrosive film on the surface of the electrode, the lithium salt may be included in the electrolyte at a concentration of 0.8 M to 3.0 M, specifically, 1.0 M to 3.0 M. If the concentration of the lithium salt is lower than 0.8 M, the conductivity of the electrolyte may decrease to deteriorate the performance of the electrolyte. If the concentration of the lithium salt is higher than 3.0 M, the viscosity of the electrolyte may increase to reduce the mobility of the lithium ions and deteriorate the wettability of the electrolyte.

Meanwhile, the non-aqueous organic solvent serves as a medium through which the ions involved in an electrochemical reaction of the battery. There are no limits to the organic solvent as long as it decomposes minimally due to an oxidation reaction or the like during charging and discharging processes of the secondary battery, and exhibits desired properties together with the additives.

Specifically, the non-aqueous organic solvent may include carbonate-based, ester-based, ether-based, ketone-based, alcohol-based, or aprotic solvent, which may be used alone or in combinations of two or more thereof.

Among the non-aqueous organic solvent, the carbonate-based solvent may include one or more solvents selected from a group consisting of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and mixtures thereof.

The ester-based solvent may include one or more solvents selected from a group consisting of methyl acetate, ethyl acetate, n-propyl acetate, dimethyl acetate, methyl propionate, ethyl propionate, propyl propionate, decanolide, mevalonolactone, caprolactone, and mixtures thereof.

The ether-based solvent may include one or more solvents selected from a group consisting of dimethyl ether, diethyl ether, dipropyl ether, methylethyl ether, methylpropyl ether, ethylpropyl ether, dibutyl ether, tetraglyme, diglyme, dimethoxyethane, 2-methyl tetrahydrofuran, tetrahydrofuran, and mixtures thereof.

The ketone-based solvent may include cyclohexanone, etc.

The alcohol-based solvent may include one or more solvents selected from a group consisting of ethyl alcohol, isopropyl alcohol, and mixtures thereof.

The aprotic solvent one or more solvents selected from a group consisting of R—CN (where, R is a straight-chain, branched, or ring-structured hydrocarbon group having 2 to 20 carbon atoms, and includes a double bond aromatic ring or ether bond) and the like nitriles, dimethyl formamide and the like amides, 1,3-dioxolane and the like dioxolanes, and sulfolane.

The non-aqueous organic solvents may be used alone or in combinations of one or more thereof. When combinations of one or more non-aqueous organic solvents are used, a combination ratio may be appropriately adjusted according to desired battery performance, which are widely understood by those skilled in the art.

Alternatively, the organic solvent may include at least one solvent selected from a group consisting of high dielectric solvents and low boiling point solvents.

Specifically, the high dielectric solvent is not particularly limited as long as it is typically used in the art, and may include fluoroethylene carbonate, ethylene carbonate, propylene carbonate, butylene carbonate, 1-fluoroethylene carbonate, and the like cyclic carbonate, gamma-butyrolactone, and mixtures thereof.

The low boiling point solvent may include dimethyl carbonate, ethylmethyl carbonate, diethyl carbonate, dipropyl carbonate, and the like chain carbonate, dimethoxy ethane, diethoxy ethane, fatty acid ether derivatives, and mixtures thereof.

The organic solvent may be contained as a remainder to satisfy 100 wt % in total of the electrolyte for the lithium secondary battery.

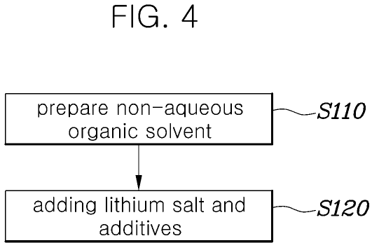

FIG. 4 is a flowchart showing how to produce an electrolyte for a lithium secondary battery according to an exemplary embodiment of the present disclosure. Referring to FIG. 4, a method of producing the electrolyte for the lithium secondary battery according to an exemplary embodiment of the present disclosure will be described.

The method of producing the electrolyte for the lithium secondary battery according to an exemplary embodiment of the present disclosure may include preparing a non-aqueous organic solvent (S110).

In the instant case, the non-aqueous organic solvent may include at least one selected from a non-aqueous organic solvent group consisting of ethylene carbonate, ethyl methyl carbonate (EMC), dimethyl carbonate (DMC) and mixtures thereof.

Furthermore, the lithium salt may include LiPF₆, and LiPF₆ may be added at a concentration of 0.8 to 3.0 M based on the electrolyte. If the concentration of the lithium salt is lower than 0.8 M, the conductivity of the electrolyte may decrease to deteriorate the performance of the electrolyte. If the concentration of the lithium salt is higher than 3.0 M, the viscosity of the electrolyte may increase to reduce the mobility of the lithium ions and deteriorate the wettability of the electrolyte.

Then, the lithium salt and the additives may be added to the non-aqueous organic solvent (S120).

In the instant case, the additives may include 1-vinyl-1,2,4-triazole, and 1-vinyl-1,2,4-triazole may be added at a content of 0.05 to 0.2 wt % based on 100 wt % in total of the electrolyte. As will be described in the following embodiments, the electrolyte for the lithium secondary battery, in which the corresponding content range of 1-vinyl-1,2,4-triazole is satisfied, exhibits excellent performance.

In addition, the additives may further include vinylene carbonate, and vinylene carbonate may be added at a content of 1.0 to 2.5 wt % based on 100 wt % in total of the electrolyte. As will be described in the following embodiments, the electrolyte for the lithium secondary battery, in which the corresponding content range of vinylene carbonate is satisfied, exhibits excellent performance.

Meanwhile, the additives may further include 1,3-propane sultone, and 1,3-propane sultone may be added at a content of 1.0 to 1.5 wt % based on 100 wt % in total of the electrolyte. As will be described in the following embodiments, the electrolyte for the lithium secondary battery, in which the corresponding content range of 1,3-propane sultone is satisfied, exhibits excellent performance.

According to an alternative embodiment of the present disclosure, there is provided a lithium secondary battery including a positive electrode that contains a positive electrode active material; a negative electrode that contains a negative electrode active material; and the electrolyte according to an exemplary embodiment of the present disclosure.

In the instant case, the lithium secondary battery according to an exemplary embodiment of the present disclosure may be manufactured by injecting the non-aqueous electrolyte of the present disclosure into an electrode structure that includes the positive electrode, the negative electrode, and a separator interposed between the positive electrode and the negative electrode. In the instant case, the positive electrode, the negative electrode, and the separator, which make up the electrode structure, may include those typically used in manufacturing the lithium secondary battery.

In more detail, the positive electrode active material of the lithium secondary battery according to an exemplary embodiment of the present disclosure may include a material represented by a chemical formula 1, which may be a carbon-coated positive electrode active material of which the surface is modified with carbon. In this regard, detailed descriptions will be made.

LiFeMPO₄ [Chemical formula 1]
where, M is Ni, Co, Mn, Cr, Zr, Nb, Cu, V, Ti, Zn, Al, Ga and Mg.

In particular, LiFeMnPO₄ may have an olivine structure.

Furthermore, the negative electrode active material may include one among a carbon-based material, a silicon-based material or mixtures thereof.

First, the positive electrode may be prepared by forming a positive electrode mixture layer on a positive electrode current collector. The positive electrode mixture layer may be formed by coating a positive electrode slurry including the positive electrode active material, a binder, a conductive material, a solvent, etc. on the positive electrode current collector, and drying and rolling the positive electrode current collector coated with the positive electrode slurry.

The positive electrode current collector is not particularly limited as long as it is conductive without causing chemical changes in that battery. For example, the positive electrode current collector may include stainless steel, aluminum, nickel, titanium, calcined(baked) carbon, or aluminum or stainless steel that has undergone surface treatment with carbon, nickel, titanium, silver, etc. In particular, the positive electrode active material may undergo the surface treatment as coated or modified with carbon.

The positive electrode active material is a lithium compound reversible between lithiation and de-lithiation, and may specifically include lithium composite metal oxide that contains lithium and one or more metals such as cobalt, manganese, nickel or aluminum.

Lithium composite metal oxide may include any one of lithium-manganese-based oxides (e.g., LiMnO₂, LiMn₂O₄, etc.), lithium-cobalt-based oxides (e.g., LiCoO₂, etc.), lithium-nickel-based oxides (e.g., LiNiO₂, etc.), lithium-nickel-manganese-based oxides (e.g., LiNi_{1-Y}Mn_{Y}O₂ (where, 0<Y<1), etc.), lithium-nickel-manganese-cobalt-based oxides (e.g., Li(NiₚCo_{q}Mnᵣ₁)O₂ (where, 0<p<1, 0<q<1, 0<r1<1, p+q+r1=1) or Li(Niₚ₁Co_{q1}Mnᵣ₂)O₄ (where, 0<p1<2, 0<q1<2, 0<r2<2, p1+q1+r2=2), etc.), or lithium-nickel-cobalt-transition metal (M) oxides (e.g., Li(Niₚ₂Co_{q2}Mnᵣ₃Mₛ₂)O₂ (where, M is selected from a group consisting of Al, Fe, V, Cr, Ti, Ta, Mg and Mo, and p2, q2, r3 and s2 are atomic fractions of independent elements, which satisfy 0<p2<1, 0<q2<1, 0<r3<1, 0<s2<1, and p2+q2+r3+s2=1)), etc., or two or more compounds thereof.

Among them, lithium composite metal oxide may be LiCoO2, LiMnO₂, LiNiO₂, lithium-nickel-manganese-cobalt oxides (e.g., Li(Ni_{0.33}Mn_{0.33}Co_{0.33})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, Li(Ni_{0.8}Mn_{0.1}Co_{0.1})O₂, etc.), or lithium-nickel-cobalt-aluminum oxides (e.g., Li(Ni_{0.8}Co_{0.15}Al_{0.05})O₂, etc.), etc. to improve the capacity characteristics and stability of the battery.

Specifically, the positive electrode active material may include a material represented by the chemical formula 1.

LiFeMPO₄ [Chemical formula 1]
where, M is Ni, Co, Mn, Cr, Zr, Nb, Cu, V, Ti, Zn, Al, Ga and Mg.

In particular, LiFeMnPO₄ may have an olivine structure.

1-vinyl-1,2,4-triazole contained in the electrolyte for the lithium secondary battery according to an exemplary embodiment of the present disclosure may decompose on the surface of the negative electrode, form a layer that protects the negative electrode, and form a nitrogen-based CEI layer excellent in high-temperature durability in the positive electrode. With this, the elution of transition metal from the positive electrode is suppressed, and the self-discharge of the secondary battery is alleviated, thereby improving high-temperature durability performance and cycle performance, and thus improving the high-temperature durability performance of the battery.

Furthermore, the electron-rich triazole structure of 1-vinyl-1,2,4-triazole effectively forms a coordination structure in the electrolyte so that Fe²⁺ ions eluted from the positive electrode cannot be electrodeposited on the negative electrode, and the nitrogen atoms present in the molecular structure of 1-vinyl-1,2,4-triazole stabilizes a LiPF₆ (LFP) salt to improve the high-temperature life characteristics of the battery.

Such properties of 1-vinyl-1,2,4-triazole may cause the lithium secondary battery using an LFP-based positive electrode active material, of which the electronic conductivity and the ionic conductivity are low, to be improved in high-temperature storage, low-temperature output characteristics, and long-term life performance.

The positive electrode active material may be contained by 80 to 99 wt % based on 100 wt % in total of solid content in the positive electrode slurry.

The binder refers to a component that assists in bonding between the active material and the conductive material or the like, and bonding to the current collector, and may be typically added at a content of 1 to 30 wt % based on 100 wt % in total of solid content in the positive electrode slurry.

As an example of the binder, there are polyvinylidene fluoride (PVDF), polyvinyl alcohol, carboxymethylcellulose (CMC), starch, hydroxypropylcellulose, regenerated cellulose, polyvinylpyrrolidone, tetrafluoroethylene, polyethylene, polypropylene, ethylene-propylene-dienter polymer (EPDM), sulfonated EPDM, styrene-butadiene rubber, fluorine rubber, various copolymers, etc.

The conductive material is typically added at a content of 1 to 30 wt % based on 100 wt % in total of solid content in the positive electrode slurry.

Such a conductive material is not particularly limited as long as it is conductive without causing chemical changes in that battery.

For example, graphite; carbon-based materials such as carbon black, acetylene black, Ketjen black, channel black, furnace black, lamp black, and thermal black; conductive fibers such as carbon fiber or metal fiber; metal powders such as carbon fluoride, aluminum, and nickel powder; conductive whiskeys such as zinc oxide, and potassium titanate; conductive metal oxides such as titanium oxide; polyphenylene derivatives and the like conductive materials may be used. As specific examples of a commercially available conductive material, there are acetylene black (Chevron Chemical Company), Denka black (Denka Singapore Private Limited), Gulf Oil Company products, etc., Ketjen black, EC-based (Armak Company product), Vulcan XC-72 (Cabot Company) products, Super P (Timcal Company product), etc.

The solvent may include an organic solvent such as NMP(N-methyl-2-pyrrolidone), and may be used in an amount to make a desired viscosity when the positive electrode active material and optionally the binder, the conductive material, etc. are comprised therein.

For example, the solid content may be contained at a concentration of 50 to 95 wt %, preferably 70 to 90 wt % in the slurry that contains the positive electrode active material, and optionally the binder and the conductive material.

Furthermore, the negative electrode may be prepared by forming a negative electrode mixture layer on a negative electrode current collector. The negative electrode mixture layer may be formed by coating slurry including a negative electrode active material, a binder, a conductive material, a solvent, etc. on the negative electrode current collector, and drying and rolling the negative electrode current collector coated with the slurry.

The negative electrode current collector generally has a thickness of 3 to 500 μm. Such a negative electrode current collector is not particularly limited as long as it is conductive without causing chemical changes in that battery.

For example, the negative electrode current collector may include copper, stainless steel, aluminum, nickel, titanium, (calcined)baked carbon, or copper or stainless steel that has undergone surface treatment with carbon, nickel, titanium, silver, etc. In particular, aluminum-cadmium alloy or the like may be used in the negative electrode current collector.

Furthermore, like the positive electrode current collector, the negative electrode current collector may be formed with fine unevenness on the surface thereof to strengthen the bonding of the negative electrode active material, and may be used in various forms such as a film, a sheet, a foil, a net, a porous material, a foaming material, and a non-woven fabric.

Furthermore, the negative electrode active material may include any one selected from a group consisting of lithium-containing titanium composite oxides (LTO); carbon-based materials such as non-graphitized carbon, and graphite-based carbon; metal composite oxides such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, elements in Groups I, II and III and halogens in the periodic table; 0<x<1; 1<y<3; 1<z<8); lithium metal; lithium alloy; silicon-based alloy; tin-based alloy; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; and conductive polymers such as polyacetylene, or a mixture of two or more thereof.

The negative electrode active material may be contained by 80 wt % to 99 wt % based on 100 wt % in total of solid content in the negative electrode slurry.

The binder refers to a component that assists in bonding the conductive material, the active material and the current collector, and is typically added at a content of 1 to 30 wt % based on 100 wt % in total of solid content in the negative electrode slurry.

As an example of the binder, there are polyvinylidene fluoride (PVDF), polyvinylalcohol, carboxymethylcellulose (CMC), starch, hydroxypropylcellulose, regenerated cellulose, polyvinylpyrrolidone, tetrafluoroethylene, polyethylene, polypropylene, ethylene-propylene-diene polymer (EPDM), sulfonated-EPDM, styrene-butadiene rubber, florine rubber, various copolymers thereof, etc.

The conductive material refers to a component for further improving the conductivity of the negative electrode active material, and may be added at a content of 1 to 20 wt % based on 100 wt % in total of solid content in the negative electrode slurry.

Such a conductive material is not particularly limited as long as it is conductive without causing chemical changes in that battery.

For example, the conductive material may include graphite such as natural graphite or artificial graphite; carbon black such as acetylene black, Ketjen black, channel black, furnace black, lamp black, and thermal black; conductive fibers such as carbon fiber or metal fiber; metal powder such as carbon fluoride, aluminum, and nickel powder; conductive whiskeys such as zinc oxide, and potassium titanate; conductive metal oxide such as titanium oxide; conductive materials such as polyphenylene derivatives, etc.

The solvent may include water or an organic solvent such as NMP and alcohol, and may be used in an amount to make a desired viscosity when the negative electrode active material and optionally the binder, the conductive material, etc. are comprised therein. For example, the solid content may be contained at a concentration of 50 to 95 wt %, preferably 70 to 90 wt % in the slurry that contains the positive electrode active material, and optionally the binder and the conductive material.

The separator, which serves to block an internal short-circuit between both electrodes and be impregnated with the electrolyte, may be formed by mixing a polymer resin, a filler, and a solvent to prepare a separator composition, and directly coating and drying the separator composition on the electrode to form a separator film, or by casting and drying the separator composition on a support, and then laminating the separator film peed from the support on the electrode.

The separator may be formed of a typically used porous polymer film. For example, a porous polymer film made of polyolefin polymers such as ethylene homopolymer, propylene homopolymer, ethylene/butene copolymers, ethylene/hexene copolymers and ethylene/methacrylate copolymers may be used alone, or the porous polymer films may be laminated to form the separator. Alternatively, the separator may be formed of a typical porous non-woven fabric. For example, a nonwoven fabric such as a high melting-point glass fiber and polyethylene terephthalate fiber may be used to for the separator. However, the material for the separator is not limited to these materials.

In the instant case, the porous separator may generally have a pore diameter of 0.01 to 50 μm, and a porosity of 5 to 95%. Furthermore, the porous separator may generally have a thickness of 5 to 300 μm.

There are no particular limits to the outer appearance of the lithium secondary battery according to an exemplary embodiment of the present disclosure. For example, the lithium secondary battery according to an exemplary embodiment of the present disclosure may be formed of a can shaped like a cylinder, a prism, a pouch, a coin, etc.

Below, various exemplary embodiments are presented to help the understanding of the present disclosure, but the following embodiments are merely illustrative of the present disclosure and not limit the present disclosure.

### EMBODIMENTS AND COMPARATIVE EXAMPLES

### Embodiment 1

A lithium secondary battery was manufactured with a positive electrode containing a positive electrode active material of LiFePO₄ (LFP), a negative electrode containing a negative electrode active material of graphite, and the reference electrolyte added with 0.05 wt % of 1-vinyl-1,2,4-triazole (F1), 2.0 wt % of vinylene carbonate (VC), and 1.0 wt % of 1,3-propane sultone (PS).

In the instant case, a non-aqueous organic solvent was prepared for the reference electrolyte by adding 1.15 M of LiPF₆ to a mixed solvent of ethylene carbonate (EC): ethyl methyl carbonate(EMC): dimethyl carbonate (DMC) at a volume ratio of 30:60:10.

### Embodiment 2

A lithium secondary battery was manufactured by the same method as in the exemplary embodiment 1, except that 0.1 wt % of 1-vinyl-1,2,4-triazole (F1), 2.0 wt % of vinylene carbonate (VC), and 1.0 wt % of 1.0 wt % of 1,3-propane sultone (PS) were added.

### Embodiment 3

A lithium secondary battery was manufactured by the same method as in the exemplary embodiment 1, except that 0.2 wt % of 1-vinyl-1,2,4-triazole (F1), 2.0 wt % of vinylene carbonate (VC), and 1.0 wt % of 1,3-propane sultone (PS) were added.

### Embodiment 4

A lithium secondary battery was manufactured by the same method as in the exemplary embodiment 1, except that 0.1 wt % of 1-vinyl-1,2,4-triazole (F1), 1.0 wt % of vinylene carbonate (VC), and 1.0 wt % of 1,3-propane sultone (PS) were added.

### Embodiment 5

A lithium secondary battery was manufactured by the same method as in the exemplary embodiment 1, except that 0.1 wt % of 1-vinyl-1,2,4-triazole (F1), 2.5 wt % of vinylene carbonate (VC), 1.0 wt % of 1,3-propane sultone (PS) were added.

### Embodiment 6

A lithium secondary battery was manufactured by the same method as in the exemplary embodiment 1, except that 0.1 wt % of 1-vinyl-1,2,4-triazole (F1), 2.0 wt % of vinylene carbonate (VC), and 0.5 wt % 1,3-propane sultone (PS) were added.

### Embodiment 7

A lithium secondary battery was manufactured by the same method as in the exemplary embodiment 1, except that 0.025 wt % of 1-vinyl-1,2,4-triazole (F1), 2.0 wt % of vinylene carbonate (VC), and 1.5 wt % of 1,3-propane sultone (PS) were added.

### Comparative Example 1

A lithium secondary battery was manufactured by the same method as in the exemplary embodiment 1, except that 1-vinyl-1,2,4-triazole (F1) was not added.

### Comparative Example 2

A lithium secondary battery was manufactured by the same method as in the exemplary embodiment 1, except that 0.025 wt % of 1-vinyl-1,2,4-triazole (F1) was added.

### Comparative Example 3

A lithium secondary battery was manufactured by the same method as in the exemplary embodiment 1, except that 1-vinyl-1,2,4-triazole (F1) was added.

### Comparative Example 4

A lithium secondary battery was manufactured by the same method as in the exemplary embodiment 1, except that 0.5 wt % of 1-vinyl-1,2,4-triazole (F1) was added.

### Comparative Example 5

A lithium secondary battery was manufactured by the same method as in the exemplary embodiment 1, except that 0 wt % of 1-vinyl-1,2,4-triazole (F1), 1.0 wt % of vinylene carbonate (VC), and 1.0 wt % of 1,3-propane sultone (PS) were added, i.e., excluding 1-vinyl-1,2,4-triazole (F1).

### Comparative Example 6

A lithium secondary battery was manufactured by the same method as in the exemplary embodiment 1, except that 0.025 wt % of 1-vinyl-1,2,4-triazole (F1), 1.0 wt % of vinylene carbonate (VC), and 1.0 wt % of 1,3-propane sultone (PS) were added.

### Comparative Example 7

A lithium secondary battery was manufactured by the same method as in the exemplary embodiment 1, except that 0.05 wt % of 1-vinyl-1,2,4-triazole (F1), 1.0 wt % of vinylene carbonate (VC), and 1.0 wt % of 1,3-propane sultone (PS) were added.

### Comparative Example 8

A lithium secondary battery was manufactured by the same method as in the exemplary embodiment 1, except that 0.2 wt % of 1-vinyl-1,2,4-triazole (F1), 1.0 wt % of vinylene carbonate (VC), and 1.0 wt % of 1,3-propane sultone (PS) were added.

### Comparative Example 9

A lithium secondary battery was manufactured by the same method as in the exemplary embodiment 1, except that 0 wt % of 1-vinyl-1,2,4-triazole (F1), 2.5 wt % of vinylene carbonate (VC), and 1.0 wt % of 1,3-propane sultone (PS) were added, i.e., excluding 1-vinyl-1,2,4-triazole (F1).

### Comparative Example 10

A lithium secondary battery was manufactured by the same method as in the exemplary embodiment 1, except that 0.025 wt % of 1-vinyl-1,2,4-triazole (F1), 2.5 wt % of vinylene carbonate (VC), and 1.0 wt % of 1,3-propane sultone (PS) were added.

### Comparative Example 11

A lithium secondary battery was manufactured by the same method as in the exemplary embodiment 1, except that 0.05 wt % of 1-vinyl-1,2,4-triazole (F1), 2.5 wt % of vinylene carbonate (VC), and 1.0 wt % of 1,3-propane sultone (PS) were added.

### Comparative Example 12

A lithium secondary battery was manufactured by the same method as in the exemplary embodiment 1, except that 0.2 wt % of 1-vinyl-1,2,4-triazole (F1), 2.5 wt % of vinylene carbonate (VC), and 1.0 wt % of 1,3-propane sultone (PS) were added.

### Comparative Example 13

A lithium secondary battery was manufactured by the same method as in the exemplary embodiment 1, except that 0 wt % of 1-vinyl-1,2,4-triazole (F1), 3.0 wt % of vinylene carbonate (VC), and 1.0 wt % of 1,3-propane sultone (PS) were added, i.e., excluding 1-vinyl-1,2,4-triazole (F1).

### Comparative Example 14

A lithium secondary battery was manufactured by the same method as in the exemplary embodiment 1, except that 0.025 wt % of 1-vinyl-1,2,4-triazole (F1), 3.0 wt % of vinylene carbonate (VC), and 1.0 wt % of 1,3-propane sultone (PS) were added.

### Comparative Example 15

A lithium secondary battery was manufactured by the same method as in the exemplary embodiment 1, except that 0.05 wt % of 1-vinyl-1,2,4-triazole (F1), 3.0 wt % of vinylene carbonate (VC), and 1.0 wt % of 1,3-propane sultone (PS) were added.

### Comparative Example 16

A lithium secondary battery was manufactured by the same method as in the exemplary embodiment 1, except that 0.1 wt % of 1-vinyl-1,2,4-triazole (F1), 3.0 wt % of vinylene carbonate (VC), and 1.0 wt % of 1,3-propane sultone (PS) were added.

### Comparative Example 17

A lithium secondary battery was manufactured by the same method as in the exemplary embodiment 1, except that 0.2 wt % of 1-vinyl-1,2,4-triazole (F1), 3.0 wt % of vinylene carbonate (VC), and 1.0 wt % of 1,3-propane sultone (PS) were added.

### Comparative Example 18

A lithium secondary battery was manufactured by the same method as in the exemplary embodiment 1, except that 0 wt % of 1-vinyl-1,2,4-triazole (F1), 2.0 wt % of vinylene carbonate (VC), and 0.5 wt % of 1,3-propane sultone (PS) were added, i.e., excluding 1-vinyl-1,2,4-triazole (F1).

### Comparative Example 19

A lithium secondary battery was manufactured by the same method as in the exemplary embodiment 1, except that 0.025 wt % of 1-vinyl-1,2,4-triazole (F1), 2.0 wt % of vinylene carbonate (VC), and 0.5 wt % of 1,3-propane sultone (PS) were added.

### Comparative Example 20

A lithium secondary battery was manufactured by the same method as in the exemplary embodiment 1, except that 0.05 wt % of 1-vinyl-1,2,4-triazole (F1), 2.0 wt % of vinylene carbonate (VC), and 0.5 wt % of 1,3-propane sultone (PS) were added.

### Comparative Example 21

A lithium secondary battery was manufactured by the same method as in the exemplary embodiment 1, except that 0.2 wt % of 1-vinyl-1,2,4-triazole (F1), 2.0 wt % of vinylene carbonate (VC), and 0.5 wt % of 1,3-propane sultone (PS) were added.

### Comparative Example 22

A lithium secondary battery was manufactured by the same method as in the exemplary embodiment 1, except that 0 wt % of 1-vinyl-1,2,4-triazole (F1), 2.0 wt % of vinylene carbonate (VC), and 1.5 wt % of 1,3-propane sultone (PS) were added, i.e., excluding 1-vinyl-1,2,4-triazole (F1).

### Comparative Example 23

A lithium secondary battery was manufactured by the same method as in the exemplary embodiment 1, except that 0.025 wt % of 1-vinyl-1,2,4-triazole (F1), 2.0 wt % of vinylene carbonate (VC), and 1.5 wt % of 1,3-propane sultone (PS) were added.

### Comparative Example 24

A lithium secondary battery was manufactured by the same method as in the exemplary embodiment 1, except that 0.05 wt % of 1-vinyl-1,2,4-triazole (F1), 2.0 wt % of vinylene carbonate (VC), and 1.5 wt % of 1,3-propane sultone (PS) were added.

### Comparative Example 25

A lithium secondary battery was manufactured by the same method as in the exemplary embodiment 1, except that 0.2 wt % of 1-vinyl-1,2,4-triazole (F1), 2.0 wt % of vinylene carbonate (VC), and 1.5 wt % of 1,3-propane sultone (PS) were added.

### Comparative Example 26

A lithium secondary battery was manufactured by the same method as in the exemplary embodiment 1, except that 0 wt % of 1-vinyl-1,2,4-triazole (F1), 2.0 wt % of vinylene carbonate (VC), and 2.0 wt % of 1,3-propane sultone (PS) were added, i.e., excluding 1-vinyl-1,2,4-triazole (F1).

### Comparative Example 27

A lithium secondary battery was manufactured by the same method as in the exemplary embodiment 1, except that 0.025 wt % of 1-vinyl-1,2,4-triazole (F1), 2.0 wt % of vinylene carbonate (VC), and 2.0 wt % of 1,3-propane sultone (PS) were added.

### Comparative Example 28

A lithium secondary battery was manufactured by the same method as in the exemplary embodiment 1, except that 0.05 wt % of 1-vinyl-1,2,4-triazole (F1), 2.0 wt % of vinylene carbonate (VC), and 2.0 wt % of 1,3-propane sultone (PS) were added.

### Comparative Example 29

A lithium secondary battery was manufactured by the same method as in the exemplary embodiment 1, except that 0.1 wt % of 1-vinyl-1,2,4-triazole (F1), 2.0 wt % of vinylene carbonate (VC), and 2.0 wt % of 1,3-propane sultone (PS) were added.

### Comparative Example 30

A lithium secondary battery was manufactured by the same method as in the exemplary embodiment 1, except that 0.2 wt % of 1-vinyl-1,2,4-triazole (F1), 2.0 wt % of vinylene carbonate (VC), and 2.0 wt % of 1,3-propane sultone (PS) were added.

### Comparative Example 31

A lithium secondary battery was manufactured by the same method as in the exemplary embodiment 1, except that 1-vinyl-1,2,4-triazole (F1), vinylene carbonate (VC), and 1,3-propane sultone (PS) were all not added.

### Comparative Example 32

A lithium secondary battery was manufactured by the same method as in the exemplary embodiment 1, except that 0.025 wt % of 1-vinyl-1,2,4-triazole (F1) was added but vinylene carbonate (VC) and 1,3-propane sultone (PS) were not added.

### Comparative Example 33

A lithium secondary battery was manufactured by the same method as in the exemplary embodiment 1, except that 0.05 wt % of 1-vinyl-1,2,4-triazole (F1) was added but vinylene carbonate (VC) and 1,3-propane sultone (PS) were not added.

### Comparative Example 34

A lithium secondary battery was manufactured by the same method as in the exemplary embodiment 1, except that 0.1 wt % of 1-vinyl-1,2,4-triazole (F1) was added but vinylene carbonate (VC) and 1,3-propane sultone (PS) were not added.

### Comparative Example 35

A lithium secondary battery was manufactured by the same method as in the exemplary embodiment 1, except that 0.2 wt % of 1-vinyl-1,2,4-triazole (F1) was added but vinylene carbonate (VC) and 1,3-propane sultone (PS) were not added.

### EXPERIMENTAL EXAMPLE

### High Temperature Life Capacity Retention

The batteries manufactured in the exemplary embodiments 1 to 7 and the comparative examples 1 to 35 were charged and discharged using a CC-CV charging method. Specifically, were performed 200 times at a high temperature of 45° C. and a C-rate of 1.0C.

After the charging and discharging cycles for the batteries manufactured in the exemplary embodiment 1 to 7 and the comparative examples 1 to 35 were performed 200 times, the life capacity retention was obtained using the following equation 1.

Life capacity retention [discharge capacity after 200 charging and discharging cycles/initial discharge capacity after single charging and discharging cycle] [Equation 1]

TABLE 1

| | | | | Life capacity |
|---|---|---|---|---|
| | Additives (wt %) | | | retention (%) |
| | F1 | VC | PS | 200 cyc |
| Embodiment 1 | 0.05 | 2.0 | 1.0 | 85.4 |
| Embodiment 2 | 0.1 | 2.0 | 1.0 | 90.0 |
| Embodiment 3 | 0.2 | 2.0 | 1.0 | 85.6 |
| Embodiment 4 | 0.1 | 1.0 | 1.0 | 86.5 |
| Embodiment 5 | 0.1 | 2.5 | 1.0 | 85.8 |
| Embodiment 6 | 0.1 | 2.0 | 0.5 | 86.8 |
| Embodiment 7 | 0.1 | 2.0 | 1.5 | 85.7 |
| Comparative example 1 | — | 2.0 | 1.0 | 85.5 |
| Comparative example 2 | 0.025 | 2.0 | 1.0 | 84.8 |
| Comparative example 3 | 0.3 | 2.0 | 1.0 | 79.2 |
| Comparative example 4 | 0.5 | 2.0 | 1.0 | 77.0 |
| Comparative example 5 | — | 1.0 | 1.0 | 84.3 |
| Comparative example 6 | 0.025 | 1.0 | 1.0 | 83.9 |
| Comparative example 7 | 0.05 | 1.0 | 1.0 | 84.7 |
| Comparative example 8 | 0.2 | 1.0 | 1.0 | 84.0 |
| Comparative example 9 | — | 2.5 | 1.0 | 85.0 |
| Comparative example 10 | 0.025 | 2.5 | 1.0 | 84.4 |
| Comparative example 11 | 0.05 | 2.5 | 1.0 | 84.9 |
| Comparative example 12 | 0.2 | 2.5 | 1.0 | 84.4 |
| Comparative example 13 | — | 3.0 | 1.0 | 82.0 |
| Comparative example 14 | 0.025 | 3.0 | 1.0 | 82.1 |
| Comparative example 15 | 0.05 | 3.0 | 1.0 | 82.4 |
| Comparative example 16 | 0.1 | 3.0 | 1.0 | 82.2 |
| Comparative example 17 | 0.2 | 3.0 | 1.0 | 79.1 |
| Comparative example 18 | — | 2.0 | 0.5 | 85.3 |
| Comparative example 19 | 0.025 | 2.0 | 0.5 | 84.8 |
| Comparative example 20 | 0.05 | 2.0 | 0.5 | 85.4 |
| Comparative example 21 | 0.2 | 2.0 | 0.5 | 83.4 |
| Comparative example 22 | — | 2.0 | 1.5 | 84.2 |
| Comparative example 23 | 0.025 | 2.0 | 1.5 | 84.0 |
| Comparative example 24 | 0.05 | 2.0 | 1.5 | 84.3 |
| Comparative example 25 | 0.2 | 2.0 | 1.5 | 82.0 |
| Comparative example 26 | — | 2.0 | 2.0 | 83.0 |
| Comparative example 27 | 0.025 | 2.0 | 2.0 | 83.2 |
| Comparative example 28 | 0.05 | 2.0 | 2.0 | 83.3 |
| Comparative example 29 | 0.1 | 2.0 | 2.0 | 83.7 |
| Comparative example 30 | 0.2 | 2.0 | 2.0 | 77.0 |
| Comparative example 31 | — | — | — | 83.6 |
| Comparative example 32 | 0.025 | — | — | 83.6 |
| Comparative example 33 | 0.05 | — | — | 83.8 |
| Comparative example 34 | 0.1 | — | — | 84.7 |
| Comparative example 35 | 0.2 | — | — | 79.5 |

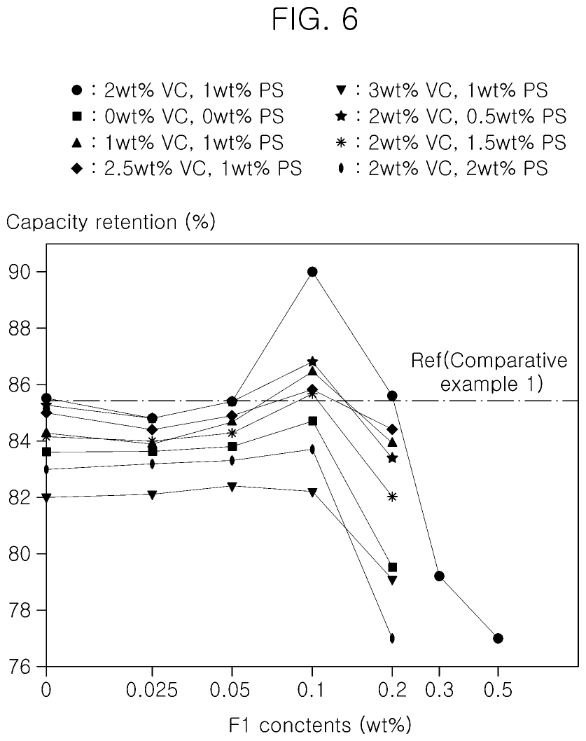

In FIG. 6 and Table 1, F1 indicates to 1-vinyl-1,2,4-triazole, VC indicates to vinylene carbonate, and PS indicates to 1,3-propane sultone.

Each content of the additives was expressed based on 100 wt % in total of the electrolyte.

For example, the total electrolyte in the exemplary embodiment 1 contains 0.05 wt % of F1, 2.0 wt % of VC, and 1.0 wt % of PS.

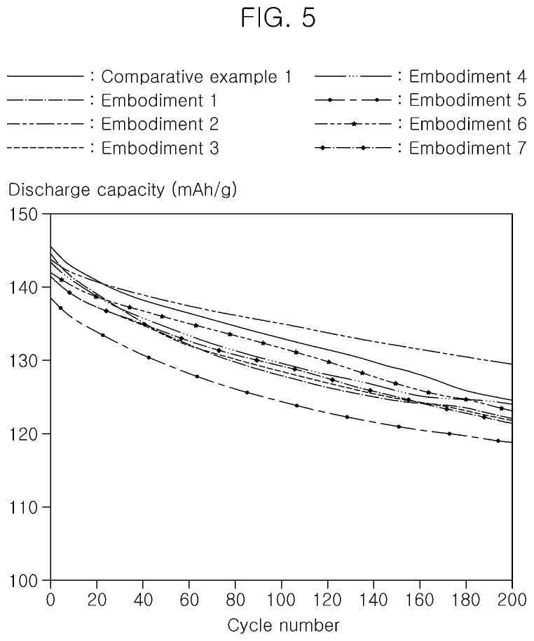

As shown in FIG. 5 and FIG. 6 and Table 1, the lithium secondary batteries of the embodiments 1 to 7, which contain the additives of 1-vinyl-1,2,4-triazole, exhibited relatively improved room-temperature capacity retention and high-temperature output performance as compared with those of the comparative examples 1 to 35.

In particular, the lithium secondary batteries of the embodiments 1 to 7 had a life capacity retention of 85% or more, and the lithium secondary battery of the exemplary embodiment 2 had a life capacity retention of 90.0%. As compared with the lithium secondary batteries of the comparative examples 1 to 35, which had a life capacity retention of 85% or less, the lithium secondary battery according to an exemplary embodiment of the present disclosure has the excellent life capacity retention even though the charging and discharging cycles were repeated 200 or more times because the electrolyte for the lithium secondary battery according to an exemplary embodiment of the present disclosure contributes to the stability of the lithium secondary battery.

In this way, 1-vinyl-1,2,4-triazole contained in an electrolyte for a lithium secondary battery according to an exemplary embodiment of the present disclosure decomposes on the surface of a negative electrode and forms a layer for protecting the negative electrode, and forms a nitrogen-based CEI layer excellent in high-temperature durability on a positive electrode, so that the elution of transition metal from the positive electrode can be suppressed, and the self-discharge of the secondary battery can be alleviated, thereby improving high-temperature durability performance and cycle performance, and thus improving the high-temperature durability performance of the battery. Furthermore, the electron-rich triazole structure of 1-vinyl-1,2,4-triazole effectively forms a coordination structure in the electrolyte so that Fe²⁺ ions eluted from the positive electrode cannot be electrodeposited on the negative electrode, and nitrogen atoms present in the molecular structure of 1-vinyl-1,2,4-triazole stabilizes a LiPF₆ (LFP) salt to improve the high-temperature life characteristics of the battery.

The excellent battery performance was exhibited under the condition that the content of vinyl-1,2,4-triazole was 0.05 to 0.2 wt %, the content of vinylene carbonate was 1.0 to 2.5 wt %, and the content of 1,3-propane sultone was 1.0 to 1.5 wt % based on 100 wt % in total of the electrolyte.

With these properties, an electrolyte for a lithium secondary battery according to an exemplary embodiment of the present disclosure, which uses the LFP-based positive electrode active material having excellent electrical performance, i.e., low electronic conductivity and low ionic conductivity, has effects on improving the high temperature storage, high-temperature life characteristics, low temperature output characteristics, and long-term life performance of the lithium secondary battery.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An electrolyte for a lithium secondary battery, the electrolyte comprising:
a lithium salt;
a non-aqueous organic solvent; and
additives comprising 1-vinyl-1,2,4-triazole.

2. The electrolyte of claim 1, wherein the lithium salt comprises LiPF₆.

3. The electrolyte of claim 1, wherein the electrolyte comprises the lithium salt at a concentration of 0.8 to 3.0 M.

4. The electrolyte of claim 1, wherein content of the 1-vinyl-1,2,4-triazole is 0.05 to 0.2 wt % based on 100 wt % in total of the electrolyte.

5. The electrolyte of claim 1, wherein the additives further comprise vinylene carbonate.

6. The electrolyte of claim 5, wherein content of the vinylene carbonate is 1.0 to 2.5 wt % based on 100 wt % in total of the electrolyte.

7. The electrolyte of claim 1, wherein the additives further comprise 1,3-propane sultone.

8. The electrolyte of claim 7, wherein content of the 1,3-propane sultone is 1.0 to 1.5 wt % based on 100 wt % in total of the electrolyte.

9. A method of producing an electrolyte for a lithium secondary battery, the method comprising:
preparing a non-aqueous organic solvent; and
adding a lithium salt and additives to the non-aqueous organic solvent,
wherein the additives comprise 1-vinyl-1,2,4-triazole.

10. The method of claim 9, wherein the non-aqueous organic solvent comprises at least one selected from a non-aqueous organic solvent group consisting of ethylene carbonate, ethyl methyl carbonate (EMC), dimethyl carbonate (DMC) and mixtures thereof.

11. The method of claim 9, wherein the lithium salt comprises LiPF₆.

12. The method of claim 9, wherein the adding the lithium salt and the additives comprises adding the lithium salt at a concentration of 0.8 to 3.0 M based on the electrolyte.

13. The method of claim 9, wherein the adding the lithium salt and the additives comprises adding the 1-vinyl-1,2,4-triazole by 0.05 to 0.2 wt % based on 100 wt % in total of the electrolyte.

14. The method of claim 9, wherein the additives further comprise vinylene carbonate.

15. The method of claim 14, wherein the adding the lithium salt and the additives comprises adding the vinylene carbonate by 1.0 to 2.5 wt % based on 100 wt % in total of the electrolyte.

16. The method of claim 9, wherein the additives further comprise 1,3-propane sultone.

17. The method of claim 16, wherein the adding the lithium salt and the additives comprises adding the 1,3-propane sultone by 1.0 to 1.5 wt % based on 100 wt % in total of the electrolyte.

18. A lithium secondary battery comprising:
the electrolyte for the lithium secondary battery of claim 1;
a positive electrode comprising a positive electrode active material that contains a material represented by chemical formula 1; and
a negative electrode comprising a negative electrode active material that contains any one of a carbon-based material, a silicon-based material, or mixtures thereof,
LiFeMPO₄ [Chemical formula 1]
where, M is Ni, Co, Mn, Cr, Zr, Nb, Cu, V, Ti, Zn, Al, Ga and Mg.

19. The method of claim 18, wherein the positive electrode active material is superficially coated with carbon.
